(19) United States
(12) Patent Application Publication
(10) Pub. No.: US 2010/0302787 A1
(43) Pub. Date: Dec. 2, 2010

(54) DECORATIVE LAMPSHADE ASSEMBLABLE IN A PERSONALIZED MANNER BY MEANS OF MODULAR TYPE ELEMENTS

(76) Inventor: Sergio Nava, Oggiono (IT)

Correspondence Address: BIRCH STEWART KOLASCH & BIRCH, PO BOX 747, FALLS CHURCH, VA, 22040-0747, US

(21) Appl. No.: 12/599,261

(22) PCT Filed: May 5, 2008
(86) PCT No.: PCT/EP2008/055494

§ 371 Date: Nov. 6, 2009

(30) Foreign Application Priority Data
May 8, 2007 (IT) MI2007U000170

(51) Int. Cl. F21V 11/00

(52) U.S. Cl. 362/351

(57) ABSTRACT

The present invention relates to a modular decorative lampshade (29) which may be freely assembled in a customized manner, by reversible attempts, by means of a fastening base (1) and of a plurality of additional elements (37) provided with at least one male insertion module (13) and at least one female insertion model (14) reciprocally insertable in a reversible manner.

The present invention relates to a modular decorative lampshade which may be freely assembled in a personalized manner, by reversible attempts, by means of modular type elements.

The decorative lampshades currently marketed are often provided completely fitted, or however in a fitting kit of well-defined components, essentially with a fixed assembling plan.

It is instead the object of the present invention to make a decorative lampshade consisting of modular elements which, by reciprocally combining a plurality of basic elements at will, allow to obtain a personalized lampshade shape and thus also a customized light quality, yet respecting the safety standards in force.

It is a further object of the modular lampshade according to the invention to provide modular elements in a range of colors and opacities so as to satisfy the buyer's creative and technical needs.

In accordance with the invention, such objects are reached by a modular decorative lampshade which may be assembled in a personalized manner, characterized in that it consists of a perforated fastening base provided with a housing for a lampholder and with a plurality of additional elements provided with through holes for the external configuration of the lampshade which may be coupled to said fastening base, and are reciprocally insertable in a reversible manner, to freely allow the progressive construction of the lampshade, by reversible attempts.

These and other features of the present invention will be further apparent from the following detailed description of an embodiment thereof, shown by way of non-limitative example in the accompanying drawings, in which:

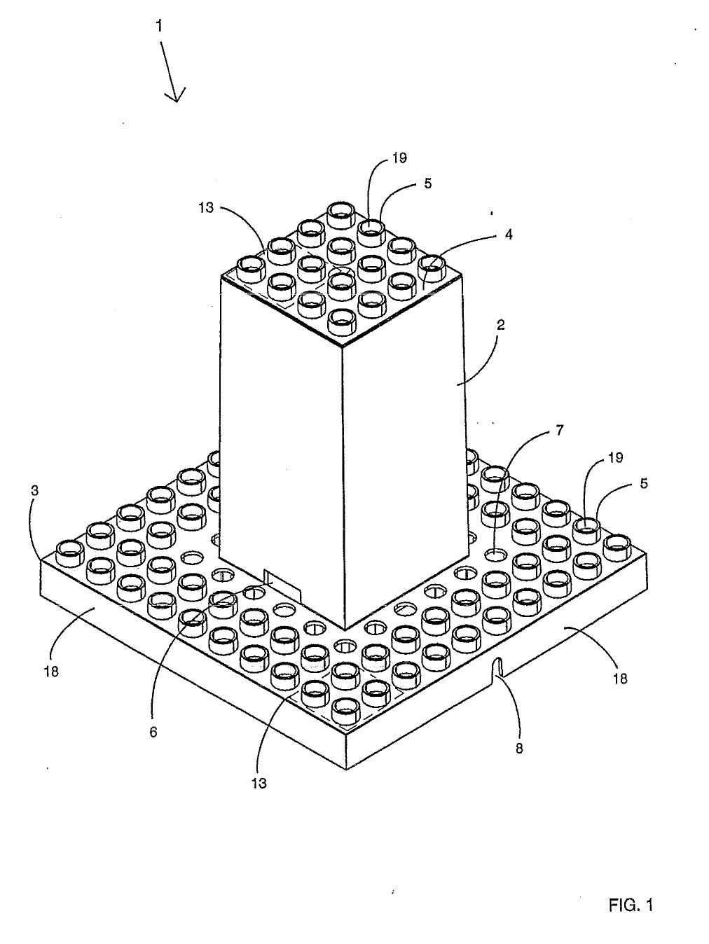

FIG. 1 shows an axonometric view from the top of the attachment base;

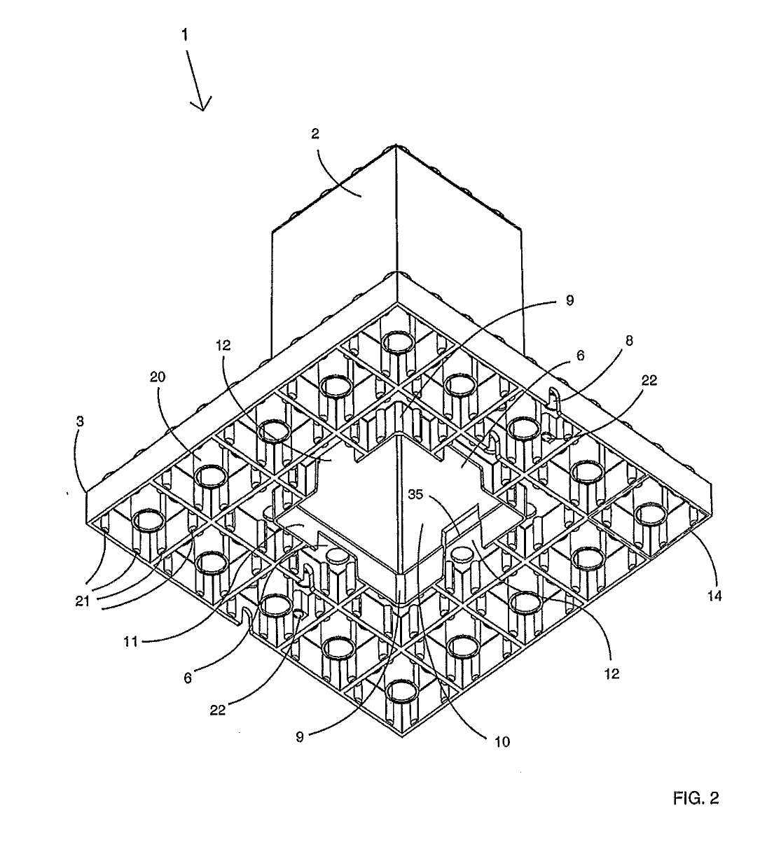

FIG. 2 shows an axonometric view from the bottom of FIG. 1;

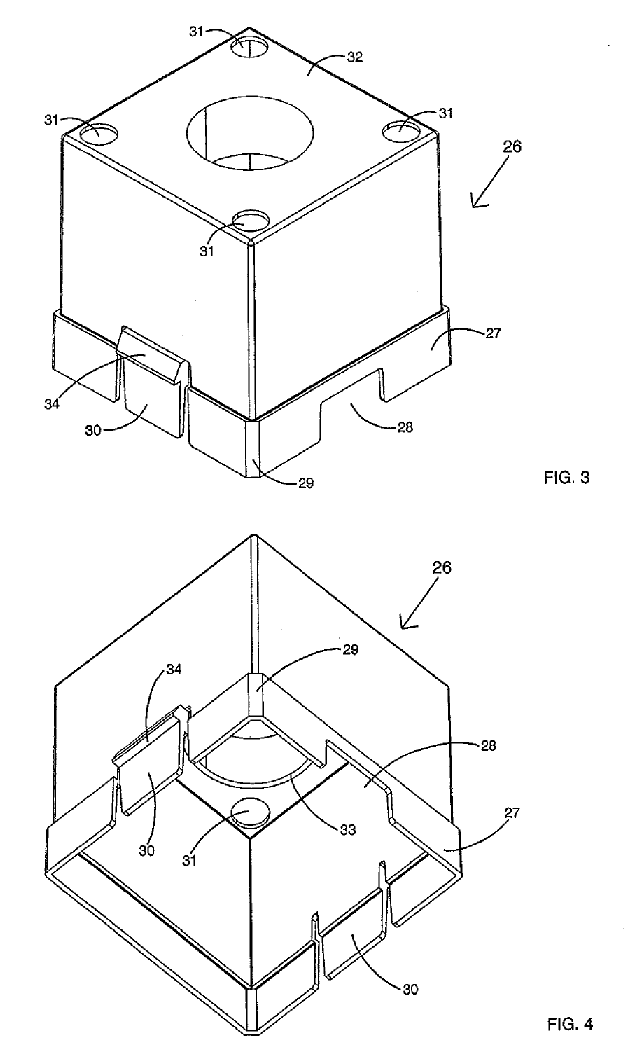

FIG. 3 shows an axonometric view from the top of the lampholder support;

FIG. 4 shows an axonometric view from the bottom of FIG. 3;

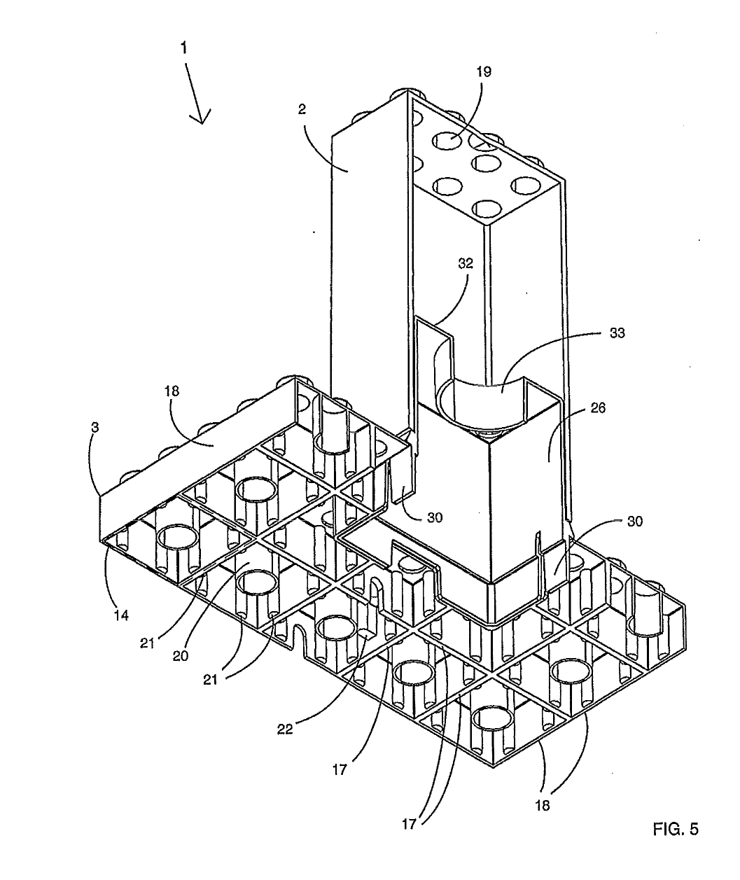

FIG. 5 shows a longitudinal section of the attachment base with the lampholder support being mounted;

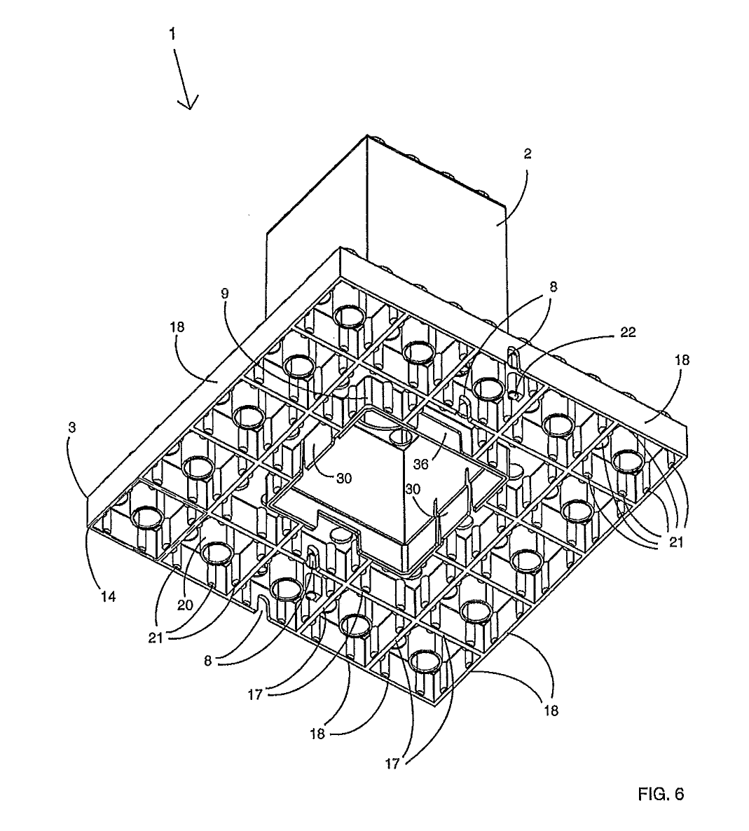

FIG. 6 shows an axonometric view from the bottom of the attachment base with the lampholder support being mounted;

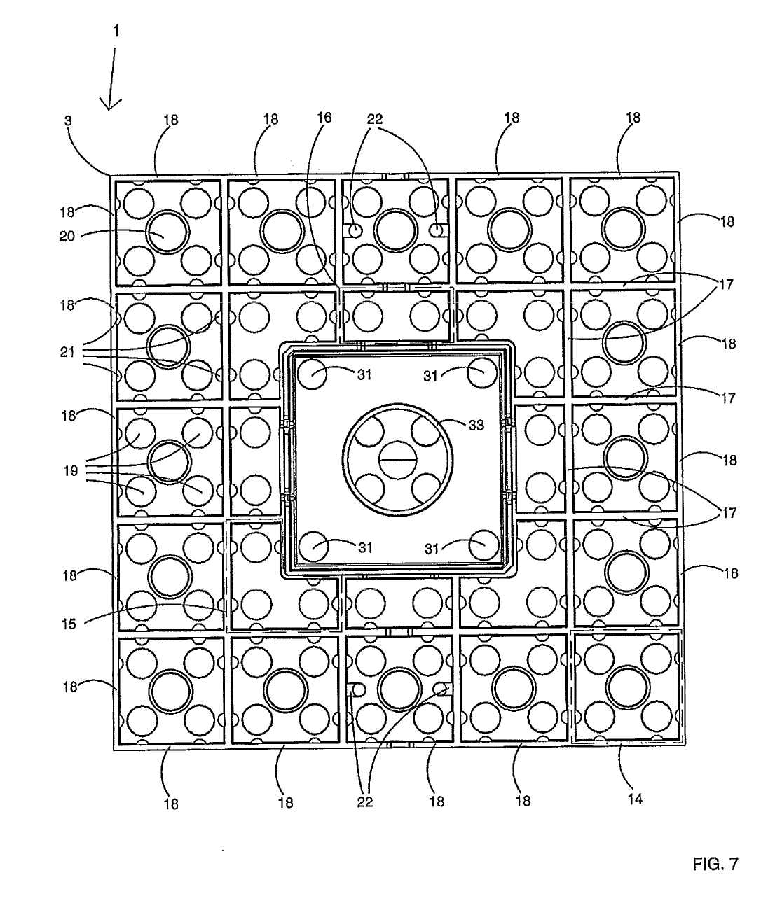

FIG. 7 shows a view from the bottom of FIG. 6;

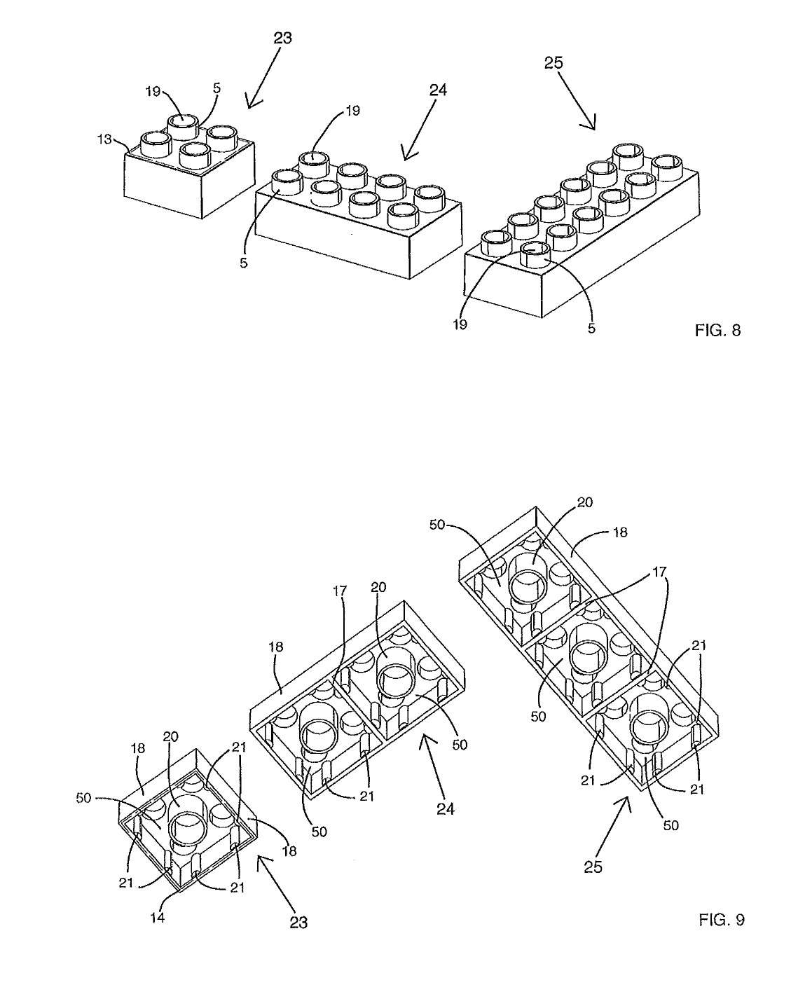

FIG. 8 shows an axonometric view from the top of three types of additional elements;

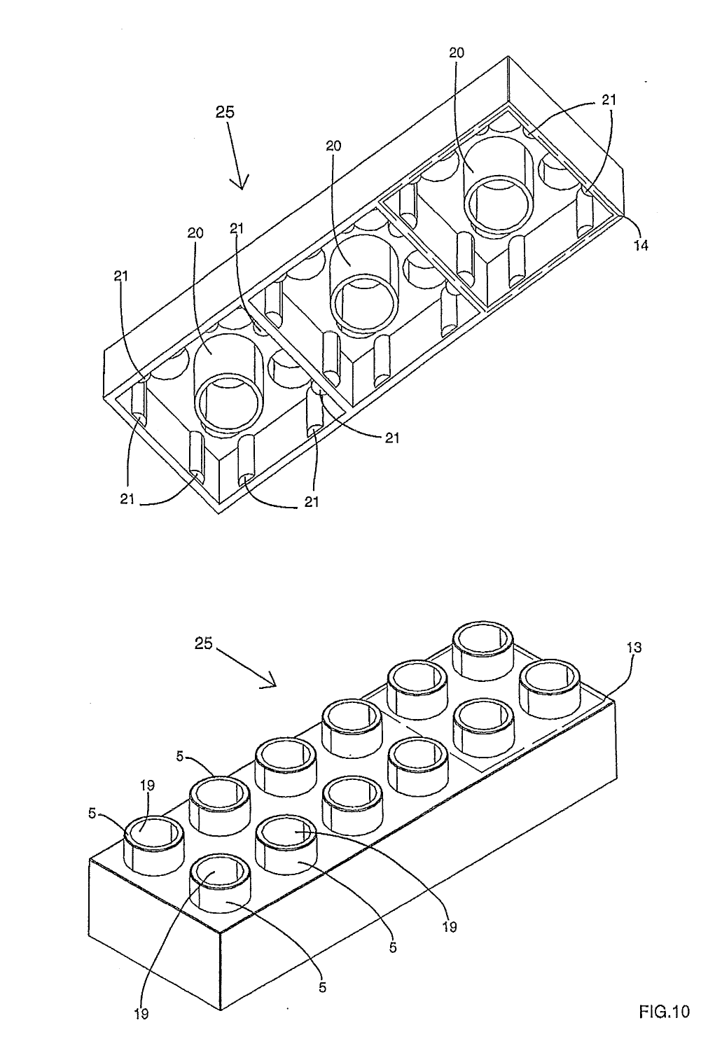

FIG. 9 shows an axonometric view from the bottom of FIG. 8;

FIG. 10 shows the inserting correspondences between two additional elements with three insertion modules;

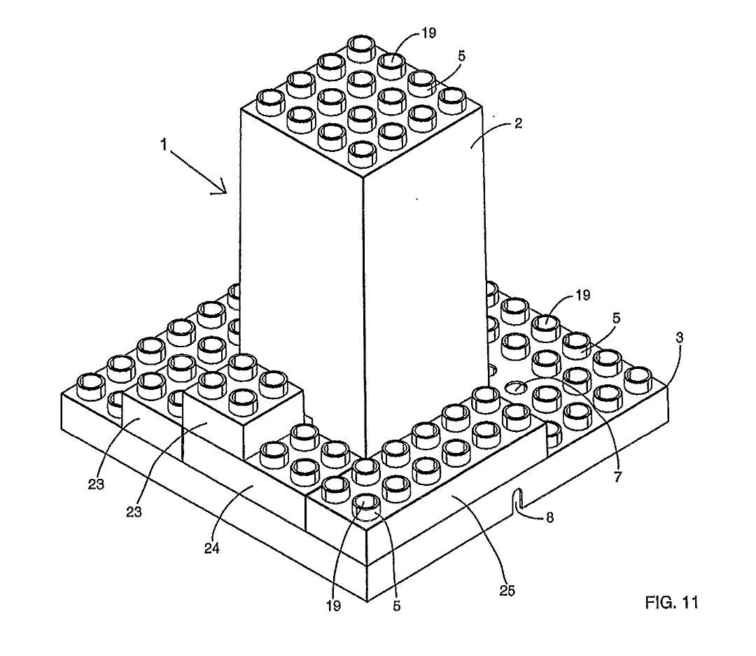

FIG. 11 shows an axonometric top view of the attachment base with four additional elements being mounted;

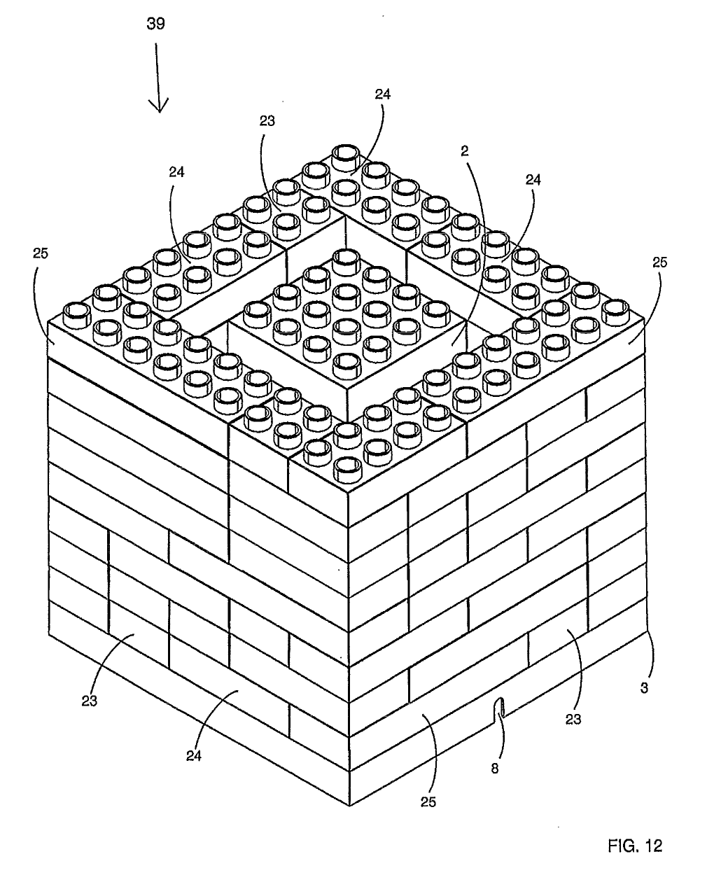

FIG. 12 shows an axonometric view of a lampshade mounted in an embodiment according to the invention.

FIGS. 1, 2, 6 and 7 show the attachment base 1 consisting of a parallelepiped portion 2 tapered upwards and by a plate base portion 3 integral with the parallelepiped portion 2.

The parallelepiped portion 2 is hollow and open towards the bottom, while the top is closed by a perforated surface 4 on which hollow cylindrical insertion elements 5 are obtained, with through holes 19, ors chimneys for the removal of heat, which put the inside of the parallelepiped portion 2 into communication with the outside. Such cylindrical insertion elements 5 are arranged according to complete male insertion modules 13, i.e. in this preferred embodiment, consisting of a square surface in which four identical cylindrical insertion elements 5 are contained with centers being arranged on the diagonals of the square surface and at equal distance from the centre of the same.

At the base of the parallelepiped portion 2, there are two openings 6, arranged in the middle of two opposite sides, for fastening the lampshade support, as will be explained below.

The plate portion 3 displays upwordly a plurality of holes 7 and they are arranged as a frame about the base of the parallelepiped section 2, the function of which is to promote the convection motions for the removal of the heat of the light bulb. Complete male insertion modules 13 are arranged, reciprocally side-by-side, about the frame of holes 7 on the upper surface of the plate portion 3. The central part of the plate portion 3 displays a cavity 10, at the parallelepiped section 2 and which continues in it, which may be used for accommodating a lampholder or for accommodating a lampholder support, and delimited by an essentially square section lead-in panel 11, for inserting a lampholder support. Such lead-in panel 11 displays two locking openings 12 in the middle of opposite sides, which continue beyond the plate portion 3, on a part of the parallelepiped portion 2, and two gripping openings 6, in the middle of the remaining sides, the functions of which in connection with the lampholder support will be explained below.

As shown in FIG. 2, the lead-in panel 11 has two keys 9 on the base, arranged at the inner corners and at the opposite ends of a diagonal of the base of the lead-in panel 11, the purpose of which, in combination with complementary bevels on the lampholder support, is to allow to fit the same in only two given orientations corresponding to two opposite sides, instead of the possible four, as will be better explained below.

The female insertion module 14 consists of a square section compartment 50 defined by flat separation panels 17 and by one or more portions of side wall 18. On the bottom of the compartment, at the cylindrical insertion elements 5, there are the through holes 19 and in the middle, integrally with the bottom of the compartment, there is the cylindrical, hollow, blank central insertion element 20. Semi-cylindrical ridges 21 are obtained on the inner walls of the compartment, essentially full-height with respect to the thickness of the plate section 3.

The plate portion 3 displays female insertion modules 14, in the lower part, corresponding to the male insertion modules 13 of the upper part.

Substantially the plate 3 displays superiorly a plurality of cylindrical insertion elements 5 with aeration through holes 19 configured according to said male insertion modules 13, and inferiorly it displays a plurality of said female insertion modules 14 or compartments 50 with central insertion element 20 and semi-cylindrical relieves 21.

Adjacent to the lead-in panel 11, in the lower part of the plate portion 3, there are partial female insertion modules 15 and bearing modules 16, similar to the female insertion modules 14, without the central insertion element 20 (FIGS. 6-7). Furthermore, being arranged about the lead-in panel 11, their shape is reduced by the presence of the lead-in panel 11 itself. The partial female insertion elements 15 preserve an insertion capacity for three cylindrical insertion elements 5, while the bearing modules 16 do not display any insertion capacity and have a partial bearing function, if taken individually. However, by way of example only, in the illustrated embodiment, it may be observed that an additional element obtained by three insertion modules side-by-side, placed between two bearing modules 16 on opposite sides, may be inserted, by means of the cylindrical insertion elements 5 of the ends of the short sides, between two bearing modules 16.

There are wire openings 8 for the passage of an electric wire in the panels 17 and in the side wall 18 of the plate portion 3. Furthermore, in each of the two complete female insertion elements 15 of two opposite sides, there is a wire ridge 22 serving for preventing the electric wire from being accidentally pulled away in combination with the central insertion element 20, with a height from the bottom such as not to interfere with the cylindrical insertion elements 5 when they are fitted.

In the embodiment shown in the drawings, on the plate base portion 3 additional elements or small bricks 23, 24 and 25 (FIGS. 8-9) are separately mounted provided superiorly with cylindrical insertion elements 5 with through holes 19, or insertion chimneys for the removal of the heat, and inferiorly they are provided with a compartment 50 with central insertion element 20 and semi-cylindrical rielieves 21 for the engagement with chimneys 5 of further bricks 23-25. Basically the upper part of bricks 23-25 takes the configuration of male insertion modules 13 of base 1, and the inferior part takes the configuration of female insertion modules 14 of the same base 1.

FIGS. 8 and 9 show by way of example only a square brick 23 with four chimneys 5, an eight chimneys 5 rectangular brick 24 and again a rectangular brick 25 with twelve chimneys 5.

In general, bricks may have various shapes, providing they are insertable one another with insertion chimneys 5 suitable for the dispersion of heat produced by the light bulb.

It is worth noting that the tapering of the parallelepiped portion 2 and the distance of the complete male insertion modules 13 from the base of the parallelepiped portion 2 is such as not to allow the insertion of additional elements on the fastening base 1, staggered by half an insertion module 38 so that they at least partially cover the portion over the holes 7, at least up to the level of the perforated surface 4. In other words, with the level being equal, between the parallelepiped portion 2 and the complete male insertion modules 13 either of the base or stacked onto this is less than half a side of a brick and gradually increases until it equals the half side of a brick at the level of the perforated surface 4. This allows to have an optimal aeration in the area near the light bulb, that is the hottest one.

At the level of the perforated surface 4, the tapering is such to allow the insertion of bricks both on the perforated surface 4, and on other stacked bricks (FIG. 12), so as to possibly cover also the area above the holes 7 at this level. Convection is guaranteed all the same by chimneys 5 of the bricks, and by the gap about the parallelepiped portion 2.

With reference to FIG. 10, in which two additional elements or bricks 25 are shown, in order to obtain a reversible insertion, the combination of the blank, central, cylindrical insertion element 20 and of the semi-cylindrical relieves 21 define constraints and the four cylindrical elements or insertion chimneys 5, being complementary, may be reversibly inserted in the free spaces.

The semi-cylindrical shape of relieves 21 is chosen for reasons of assembly, and also for the molding process both for the base and for the bricks. The material used is polycarbonate and considering that the structure is mostly transparent in order to allow the passage of light from the light bulb, it is necessary that the molding process does not present excessive shrinkage cavities, which might deteriorate the transparency quality of both the base and the bricks, which are fundamental for the trick of light produced by the whole lamp.

Furthermore, the bricks may be stacked displaced by half the width one in respect of the other, thus creating steps and not only vertical walls.

The embodiment herein described is completed by a parallelepiped-shaped lampholder support 26 (FIGS. 3-4), preferred tapered so as to be able to be inserted in the parallelepiped portion 2, but of lower height, so that after mounting the lampholder and the corresponding light bulb and inserting the lampholder support 26 in its seat, there is however a certain clearance between the light bulb and the perforated surface 4 above. An upper surface 32 of the lampholder support 26 displays in the middle a hollow cylindrical section 33 with free ends, which projects towards the inside of the support. A lampholder with the corresponding light bulb (not shown) is fitted on this section. Four recirculation holes 31 are obtained on the upper surface 32, to promote the convection that is the removal of heat. A fastening frame 27 on the base of the lampholder support 26 includes a window 28 for the passage of the electric wire, of width equal to the gripping openings 6 of the lead-in panel 11, two diametrically opposite bevels 29 which are complementary with the keys 9 in the lead-in panel 11 on the plate portion 3 serving for allowing the insertion of the lampholder support 26 with only two orientations, with respect to the fastening base 1, related to two opposite sides, instead of the possible four, and such to make the window 28 coincide with either one of the two openings 6 for the passage of the electric wire. The fastening frame 27 further displays two elastic tongues 30 arranged each in the middle of reciprocally opposite sides for fixing the lampholder support 26 to the parallelepiped portion 2.

The lampholder support 26 is to be inserted with the orientation allowed by the lead-in panel 11 so as to however guarantee the correspondence of the window 28 with one of the openings 6 of the fastening frame 27, to allow the passage of the electric wire towards the wire openings 8 and towards the wire ridges 22. The elastic tongues 30 are thus engaged in the correspondence openings 12 and the tongue ridges 34 of the tongues 30 prevent the accidental release from the support, by engaging the locking portions 35 of the plate portion 3.

The disassembly of the lampholder support 26 can be performed only by adults. Indeed, an adult sized hand is needed to free both the tongue ridges 34 at the same time, while the other hand, in order to extract the lampholder support 26, must grip and pull the free portion 36 (FIG. 6) of the lampholder support 26, at one of the openings 6.

FIG. 11 shows the attachment base 1 with four additional elements or brocks 23-25 being mounted. The frame of holes 7 remains free to improve the aeration and thus the removal of heat near the lamp.

FIG. 12 shows a lampshade 39 according to an embodiment of the invention obtained by mounting a plurality of additional elements or bricks 23-25 according to a classic tower plan. In complex structures like these, one can understand the importance of providing a plurality of chimneys 5, or perforated bricks, otherwise the plurality of bricks stacked about the lampshade holder would stifle the central portion raising the temperature in a non acceptable way, according to the regulations in force.

It is apparent that further changes and variations to both the arrangement and the shape of the parts which constitute the invention are included in the scope of the invention itself, as defined by the following claims.

1-18. (canceled)

19. A modular decorative lampshade which may be assembled in a personalized manner, comprising a perforated fastening base provided with a housing for a lampholder and with a plurality of additional elements provided with through holes for the external configuration of the lampshade which may be coupled to said fastening base and are reciprocally insertable in a reversible manner, to allow the progressive construction of the lampshade by reversible attempts, and with a free scheme.

20. The decorative lampshade according to claim 19, wherein said additional elements comprise superiorly cylindrical hollow elements with through holes and inferiorly at least a compartment perforated by said through holes with at least one central insertion element.

21. The decorative lampshade according to claim 20, wherein semi-cylindrical relieves are provided in said compartment of said cylindrical hollow elements.

22. The decorative lampshade according to claim 19, wherein said fastening base comprises superiorly a plurality of cylindrical hollow elements with through holes.

23. The decorative lampshade according to claim 22, wherein said fastening base comprises inferiorly a plurality of perforated compartments with central insertion element and a plurality of semi-cylindrical relieves.

24. The decorative lampshade according to claim 19, wherein said fastening base provides a flat perforated portion around the lamp holder.

25. The decorative lampshade according to claim 19, further comprising a lampholder support accommodated in said fastening base.

26. The decorative lampshade according to claim 19, wherein the fastening base includes a plate portion and, in the middle, of a hollow parallelepiped portion, tapered upwards and open towards the bottom.

27. The decorative lampshade according to claim 26, wherein the parallelepiped portion includes a perforated surface which closes it on top with a plurality of cylindrical hollow elements.

28. The decorative lampshade according to claim 25, wherein the lampholder support is parallelepiped-shaped and tapered, insertable in the parallelepiped portion, of lower height and on top of an upper surface thereon, having in the middle at least one element for fitting a lampholder and at least one recirculation hole, at the base a fastening frame with two elastic tongues provided with tongue ridges serving for locking the lampholder support, by engaging on locking portions of the plate portion, the fastening frame further displaying a window for the passage of an electric wire.

29. The decorative lampshade according to claim 28, wherein the lampholder support provides a hollow, holed, cylindrical assembling portion, placed on the upper surface and which projects towards the inside of the lampholder support.

30. The decorative lampshade according to claim 26, wherein the lower part of the plate portion displays a cavity in correspondence with the parallelepiped section and which continues in it, delimited by an essentially square section lead-in panel, for inserting the lampholder support, which lead-in panel displays two gripping openings, one serving for relieving a free portion on the fastening frame for gripping and extracting the lampholder support and the other serving for allowing the passage of the electric wire outwards, both placed in the middle of opposite sides, and two openings serving for accommodating the two elastic tongues, in the middle of the other two sides, the latter which continue onto the parallelepiped portion, the elastic tongues engaging with the openings of width slightly greater than that of the elastic tongues, fasten the support by means of the tongue ridges engaging the locking portions of the plate portion.

31. The decorative lampshade according to claim 30, wherein the lower part of the lead-in panel displays two keys, arranged at the inner corners and at the opposite ends of a diagonal of the panel, which by matching with the complementary bevels on the fastening frame of the lampholder support, serve for allowing the assembling of the same only in a given direction so as to align the window with one of the two openings thus allowing the electric wire out through the window.

32. The decorative lampshade according to claim 19, wherein the plate portion provides inferiorly for wire ridges, which serves for preventing the electric wire from being accidentally pulled away, in combination with respective central insertion elements, of such a height not to interfere with the insertion element when mounted.

33. The decorative lampshade according to claim 19, wherein it is made of transparent polycarbonate.

34. The decorative lampshade according to claim 19, wherein the polycarbonate has various degrees of opacity.

35. The decorative lampshade according to claim 19, wherein the polycarbonate is colored.

36. A brick for a decorative lampshade according to claim 19, wherein it is provided superiorly with cylindrical hollow elements with through holes for the removal of heat, and inferiorly with at least a compartment perforated by said through holes with at least one central insertion element and semi-cylindrical relieves, the superior part of a brick engaging reversibly with a lower part of a further brick or fastening structure so as to build a free scheme construction.
